(19) United States
(12) Patent Application Publication
(10) Pub. No.: US 2011/0286784 A1
(43) Pub. Date: Nov. 24, 2011

(54) Toothbrush with integrated toothpaste and dental floss dispensers

(76) Inventor: Cristian E. Gipson, Livermore, CA (US)

(21) Appl. No.: 12/800,861

(22) Filed: May 24, 2010

(51) Int. Cl. B43K 29/00; A61C 15/04; A46B 11/04

(52) U.S. Cl. 401/195; 401/270; 132/324

(57) ABSTRACT

A hand-held dental appliance provides a complete, portable dental care system. The appliance stores toothpaste in a toothpaste delivery canister. The appliance has a removable cover to protect a toothpaste dispensing toothbrush unit that is separably connected to the canister, The toothbrush unit has a brush head at the end of a stem ending with a connector for joining with a cooperating canister connector. When the brush unit and canister connectors are joined, a dispenser tip at the connector end of the canister fluidly communicates with a distributed orifice disposed within a bristle array on the brush head by means of a fluid-communicating passage in the stem leading from the joined connectors through the orifice. The orifice is overlapped by a set of resilient flaps enabling toothpaste to flow into the bristles but inhibiting backflow through the orifice. The size and shape of the canister enables it to be gripped for brushing with the brush head. The canister contains an toothpaste delivery actuator driving a movable member that forces the canister's stored toothpaste from the dispenser tip to the brush head through the stem passage. The protective cover includes a housing that receives and encloses the toothbrush unit through one open end. The other end of the cover includes a hinged lid that covers a dental floss dispenser contained inside the cover when the lid is closed. Lengths of floss can be cut from the floss dispenser by a cutter where it protrudes from an aperture adjacent to the lid.

### REFERENCES CITED

U.S. Patent Documents

| U.S. P/N | TITLE |
|---|---|
| 7,677,827 | Toothbrush with toothpaste dispenser |
| 7,651,012 | Toothpaste dispenser, toothpaste dispensing system and kit |
| 7,293,928 | Toothpaste dispensing toothbrush |
| 7,048,460 | Portable combination toothbrush and toothpaste dispenser |
| 6,729,789 | Toothbrush assembly with toothpaste dispenser |
| 6,685,375 | Toothpaste-dispensing toothbrush |
| 6,609,848 | Combination toothbrush and toothpaste dispenser |
| 6,273,629 | Toothpaste dispensing toothbrush |
| 6,257,791 | Toothbrush with integrated toothpaste dispenser |
| 6,213,663 | Dentifrice dispensing toothbrush device |
| 6,129,474 | Toothpaste dispensing toothbrush |
| 6,056,469 | Toothbrush with toothpaste dispensing casing |
| 6,039,489 | Paste dispensing brush |
| 6,027,273 | Toothbrush with pressurized toothpaste dispenser |
| 5,918,996 | Combination toothbrush and toothpaste dispenser |
| 5,913,632 | Refillable dentrifice dispensing toothbrush |
| 5,909,977 | Dentifrice dispensing toothbrush with refillable cartridge |
| 5,415,187 | Combination toothbrush, toothpaste dispenser and dental |
| | filament dispenser |
| 5,407,287 | Toothbrush with self-contained toothpaste dispenser |
| 5,403,105 | Toothbrush with plural supply |
| 5,066,155 | Toothbrush and paste dispenser |
| 4,733,983 | Dispenser toothbrush |
| 4,693,622 | Combined toothbrush and toothpaste dispenser |
| 4,583,563 | Combined toothbrush and toothpaste dispenser |
| 4,388,011 | Material dispenser toothbrush |
| 4,332,497 | Combination toothbrush and toothpaste dispenser |

### BRIEF DESCRIPTION OF THE SEVERAL VIEWS OF THE DRAWING

FIG. 1A:

Exploded perspective of a preferred embodiment of the present invention

FIG. 1B:

Components of FIG. 1A in storage or transport configuration.

FIG. 2A:

Cross section of brush head assembly of FIG. 1A.

FIG. 2B:

Partially cutaway view of canister of FIG. 1A.

FIG. 2C:

Partial cross section of cover and lid of alternative embodiment.

FIG. 2D:

Cross section and partial cut-away view of joined configuration of alternative embodiment of the present invention shown in FIG. 1B.

FIG. 2E:

Cross section and partial cut-away view of joined configuration of head and canister shown in FIG. 1A.

FIG. 2F, 2G, 2H: frontal view of 3 alternative brush heads for brush head assembly of FIG. 2A.

FIG. 2I: cross section of distributed orifice in FIG. 2F before delivery of toothpaste to bristles.

FIG. 2J: Cross section of orifice during delivery of toothpaste.

FIG. 2K: Cross section of orifice after delivery.

FIG. 3A and FIG. 3B: cross sections of alternative pressurized toothpaste dispenser canister.

FIGS. 4A and 4B: alternative roller actuated dispenser canister.

FIGS. 5A and 5B: alternative wiper actuated dispenser canister.

### BACKGROUND

### Field of the Invention

The present invention relates generally to a dental care apparatus and, in particular, to a self-contained toothpaste-dispensing toothbrush with dental floss dispenser.

### Related Previous Art

Toothbrushes, toothpaste dispensers and dental floss dispensers are well known. Occasionally, the multiple steps of retrieving a toothbrush, and separate toothpaste dispenser, placing toothpaste from the toothpaste dispenser onto the brushes of the toothbrush, then later finding a separate dental floss dispenser become time-consuming and tedious. At other times, one or more of the three items cannot be located, causing frustration.

It is desirable, therefore, to provide a toothbrush having a toothpaste dispenser and dental floss dispenser integrated within a single unit in order to overcome the disadvantages noted above. It is also desirable to provide a toothpaste dispenser that is reusable and/or includes replaceable components.

U.S. Pat. No. 6,729,789 by Gordon describes a toothbrush, toothpaste and dental floss dispenser combination having a spring biased cartridge 12 in a canister 11 that feeds toothpaste from the open top end of the cartridge through a passage 18 in brush head stem 19 to exit through aperture 20 in the brush head 13. Optional check valves 27 at the brush head prevent back flow of the toothpaste. A button 21 actuates valve 30, which controls the start/stop flow of toothpaste from the cartridge into the passage. The bottom end of the brush head stem and the top end of cartridge 12 are connected by releasable means such as threaded connection or bayonet type releasable connection.

Disadvantages: Gordon's cartridge is open-ended at the top and bottom so when an expended cartridge is removed and discarded, toothpaste residue is left at the rear end of the brush head and at the top of the Piston, which is messy; also handling the open-ended cartridge that is inherently messy. Also the parts count and cost of the Piston, spring control valve and button are problematic. In addition, Gordon doesn't show or describe what the check valve is. Additionally, the floss spool that 22a projects from the bottom of the canister 11 prohibits one from standing the brush 10 upright to minimize counter space when not in use.

U.S. Pat. No. 7,048,460 by Thompson, et al, shows

a portable combination toothbrush and toothpaste dispenser device 12 within a casing 15. The casing includes a toothbrush 12, a toothpaste dispenser, and includes a top end and a bottom end. The bottom end has a ribbed circular dispensing wheel 26 connected to an internal plunger assembly 28. The plunger assembly has a circular platform 25 which pushes toothpaste upwardly and a funnel cap 32 which dispenses the toothpaste outwardly onto the toothbrush 12. The toothbrush has bristles 20 and the handle 17 that extends upwardly and downwardly from within the casing. A cap 34 fits onto the bottom end of the casing in an open position ready for use and onto the top end of the casing in a closed position for storage.

Disadvantages: single dispensing funnel 32 concentrates toothpaste in one location on the bristles; when the receptacle 14 is empty and discarded, the brush is discarded along with it. Thompson doesn't show or describe how to avoid interference between the circular platform 25 and the handle 17 when the platform is moved above the bottom end of the handle

### SUMMARY OF THE INVENTION

The unitary dental care device of the present invention includes a toothbrush component, a manually controlled toothpaste dispenser component, a detachable protective cover and a dental floss dispenser component all integrated into one hand held unit. The toothbrush component has a stem with brush head at its free end and is detachably connected at its base at the other end to the top of the toothpaste dispenser component. The toothpaste dispenser component is formed as a longitudinal body formed to be easily grasped by one's hand when using the toothbrush.

The detachable cover for protecting the brush head has two sections: a longitudinal body section with separable lid at one end and an open bottom at the other end. The cover body receives the toothbrush component through its open-end and detachably connects to the outside of the stem base with the brush head and stem inside.

The dental floss dispenser is mounted to the cover body section inside the cup-shaped lid section at the top of the cover. The lid is mounted on the cover body by a hinge so it can be rotated from a closed position, protecting the floss dispenser, to an open position where the floss dispenser is exposed for use. The cover and the cap keep the other components of the unit clean and shielded from contamination during transport or storage.

The base of the toothbrush component forms a receiving cavity to make detachable connection with the dispenser component. A flow channel is formed in the stem for delivering toothpaste to the brush head. The channel leads from an open channel end at a coupling connection in the stem cavity to the brush head. When the canister and the stem base are joined, the channel delivers toothpaste from the canister to the brush head. Toothpaste is received from the canister by the coupling connection in the stem base from an open-ended dispenser tip projecting from the top end of the canister

The stem of the brush head component is preferably angled with respect to its base end providing enhanced effectiveness to the user.

A coupling connection gasket between the outside of the dispenser tip and the inside of the cavity blocks toothpaste flowing out of the tip from flowing anywhere in the cavity other than into the channel end at the connection. This prevents build-up of toothpaste residue in the cavity, keeping it clean and fresh so it doesn't have to be cleaned when the canister is empty and is replaced by a new canister.

The coupling connection allows the toothpaste canister to be separated from the brush head when the canister is empty, so a new one can replace it.

The brush head has an array of bristles on its face. The brush head face defines a distributed orifice among the bristles that connects the channel in the brush head into multiple locations along the array. The distributed orifice enables the flow of toothpaste to spread along the array. Openings in the orifice are covered by cantilever sealing members with free ends. the sealing members close off the orifice openings when in a closed rest position. the sealing members are made from a resilient material that allow the free ends to flex open, from the closed rest condition, and permits toothpaste to flow from the brush head to the bristles when it is forced from the channel. When toothpaste is no longer being forced from the channel, the resilient members relax to the closed rest condition, and inhibit backflow of toothpaste or other external material into the channel. The self-sealing orifice in the brush head helps to keep the channel clean.

Toothpaste is forced to flow from the canister into the connected channel by a forcing mechanism disposed in the canister. A preferred forcing mechanism is a movable plunger in the canister body with the stored toothpaste between the plunger and the connected channel. A threaded rod that passes through mating threads at its center manually advances the plunger when it is rotated by a rotatable knob fixed at its distal end. The rotatable knob forms part of the base of the dispenser body section. Rotating the base knob relative to the canister body advances the plunger and forces toothpaste to flow from the canister toward the bristles on the brush head.

### Advantages of the Present Invention

Advantages of the present invention include:
A self-contained assembly combining a protective cover, toothbrush, toothpaste and dental floss integrated into a single transportable, storable unit.
A self-sealing orifice in the brush head inhibits backflow of toothpaste or other external material from the bristles into the brush head channel;
Toothpaste is delivered to multiple locations among the bristle array;
The amount of toothpaste delivered to the brush head is precisely controlled by simple manual control;
Components of the assembly are separable for replacement and renewal, as desired;
Multiple instances of some components can be shared with a single set of other common components; e.g., one cover shared between a toothbrush head and canister set at home and another set for travel; or one cover and toothbrush head with two canisters, one for home and one for travel.

### DETAILED DESCRIPTION OF THE INVENTION

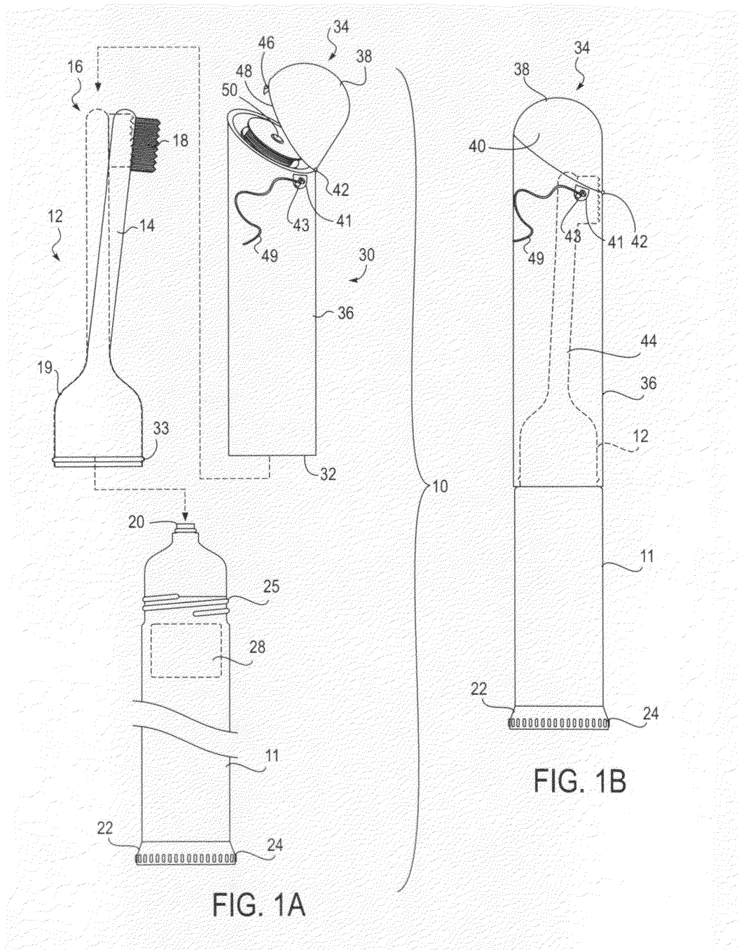

FIG. 1A, B Joined and Separated Components

Referring to FIG. 1A and 1b the toothbrush assembly according to the present invention is indicated generally at 10. The toothbrush assembly 10 includes 3 distinct and separable components (FIG. 1A) that can be joined to form a single integral unit (FIG. 1B) for storage or transport. The separate components consist of a predominantly cylindrical, rigid, longitudinal toothpaste dispenser assembly 11, a brush head assembly 12 and a hollow, generally cylindrical sanitary cover 30. The canister 11, the brush head assembly 12, and the cover 30 are preferably formed of molded plastic.

The canister 11 stores a source of toothpaste to be delivered to the brush head assembly 12.

The sanitary cover 30 is a removable shield over the brush head assembly 12 (indicated by dashed lines 44) to keep it clean when not in use.

Brush Head Assembly; External View

The head assembly 12 has a longitudinal stem 14 extending proximally from its distal end to a brush head 16 at its proximal end. The brush head 16 presents an embedded array of lateral projecting bristles 18 for brushing one's teeth.

The lower end of head assembly 12 is flared distally outward from the stem 14 to define open-ended barrel section 19 provided with a outward projecting circumferential ridge 33. The open end of barrel 19 receives the proximal end 28 of the canister 11 and engages with the canister threads 25 as described further below.

Canister Assembly; External View

A major central portion of the canister assembly 11 has a body section 9 sized for grasping by human hand. Adjacent to the upper end of the canister assembly 11 are male threads 25 removably received into the proximal lower end of toothbrush head assembly 12.

The proximal end 28 of canister 11 narrows, to an open-ended tubular dispenser tip 20. Toothpaste stored within canister 11 is transferred to the brush head assembly 12 and subsequently to the bristles 18 of the brush head 16.

The distal end of canister 11 terminates in a supporting base member 22. The base member 22 has a truncated conical section serrated with a set of notches and ridges 24 distributed around its periphery to enhance gripping by fingers of one's hand while the canister's upper body 9 is grasped by one's opposite hand.

The base 22 terminates with a flat bottom face perpendicular to the longitudinal body 9 providing stability for supporting the invention 10 in an upright orientation on a counter or sink top.

Cover 30 External View FIG. 1a, 1b.

The hollow sanitary cover 30 extends longitudinally between an open bottom end 32 and a closed upper end 34.

The open bottom end of the cover 32 removably receives the brush head assembly

The cover 30 is divided into two sections, a longitudinal lower body shell 36 and a contiguous upper lid section 38. The lid section 38 is rotatably separable from the lower section 36 by a hinge 42 at an intermediate peripheral joint 40 extending around the body of the cover 30.

In FIG. 1b the lid 38 is shown closed and latched to the proximal end of shell 36 at joint 40 defined between a lower rim of the upper section and contiguous opposing upper rim of the lower section. The upper section 38 is an inverted cup-shaped lid to close off the upper end 34 of the cover 30.

Lid 38 is rotatable about hinge 42 with respect to shell 36 so that, when closed, the cover 30 to expose the interior of lid 38 and the proximal interior of lower section 36.

A releasable latch 46 holds the lid 38 and body 36 together when the lid 38 is closed.

When the lid 38 is open, the proximal interior of the body 36 exposes a floss dispenser 48. The floss dispenser 48 is supported on a retainer 50 mounted in the body 36. Floss 49 from floss dispenser 48 protrudes through a cutting aperture 41 defined in the lid 38. Aperture 41 includes a cutter 43 for cutting off a segment of floss. The dispenser 48 and the retainer 50 can be any one of a number of configurations, such as a headed-post 54 fitted through and frictionally snapped into the center of cylindrical spool or bobbin 48.

Canisters of different capacity and types of contents may be interchangeably joined with a brush head assembly. For example, a separate canister with a small amount of toothpaste 28 limited to that required for carriage on an airplane can be attached for travel and carried conveniently in carry-on luggage.

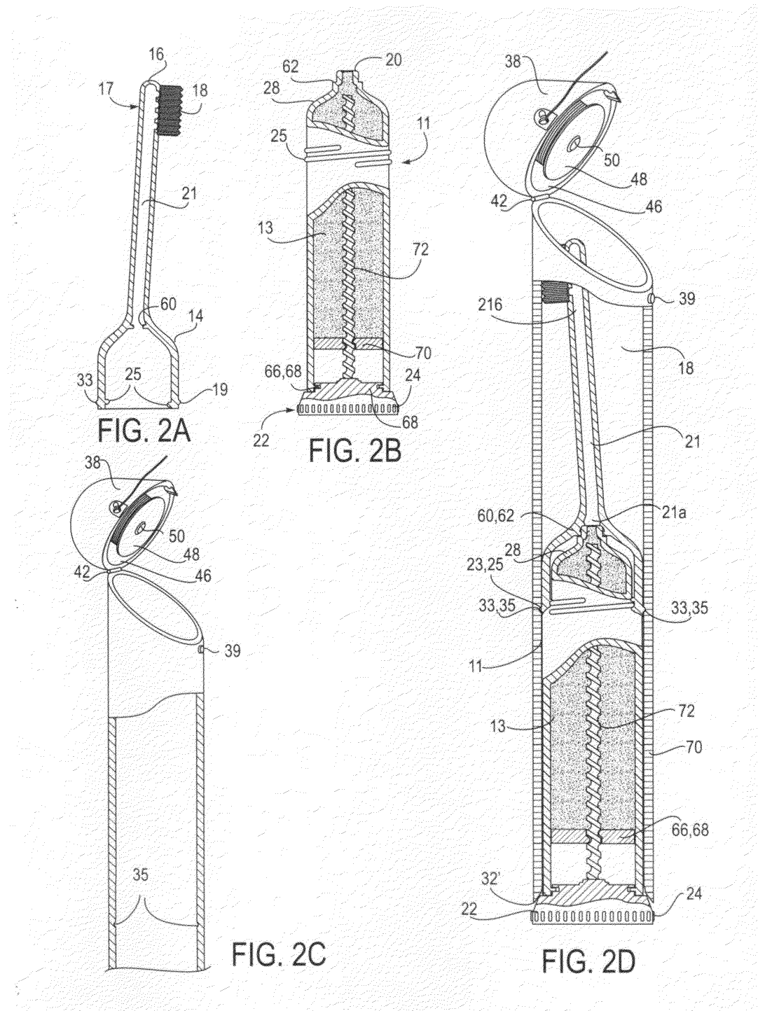

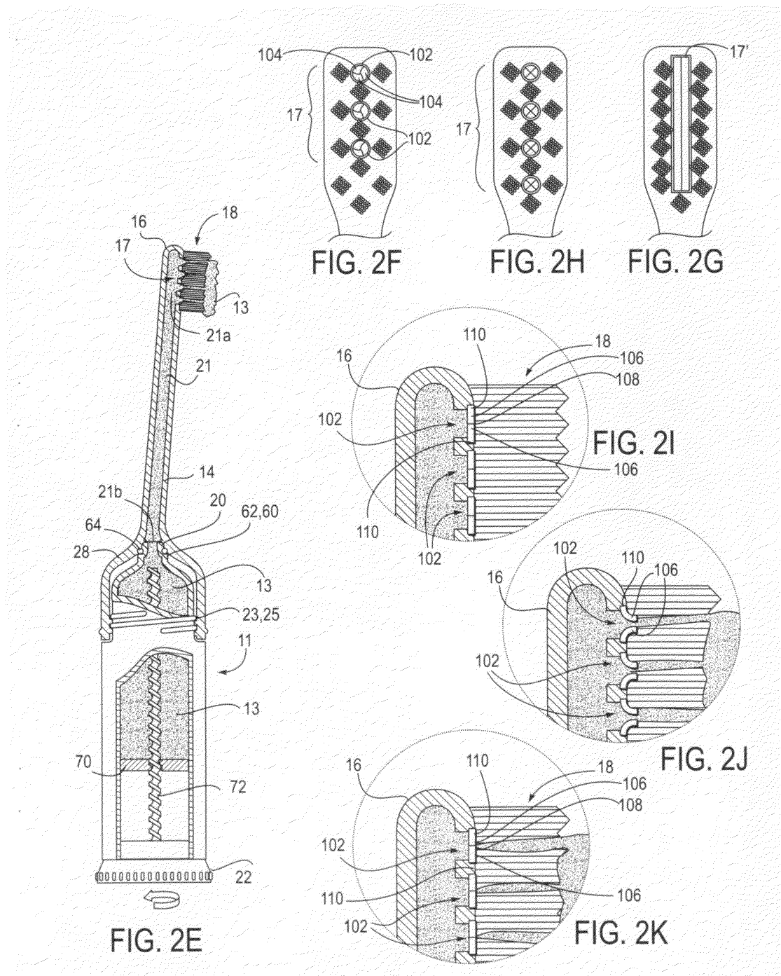

FIG. 2A Brush Head Interior

The flared end of barrel section 19 has internal female threads 23 that engage with threaded upper section 25 of canister 11. The canister 11 stores a quantity of toothpaste 13 to be delivered through dispenser tip 20 when assembled in flowing communication with the brush head assembly 12 as described further below.

as described below. 16 through a channel 21 defined in stem 14 for delivery to bristle array

FIG. 2A, b, Brush Head Barrel and Canister; Cross Section

The lower shell section 36 and the interior of the bottom end 32 are sized and shaped to form a detachable connection with the outer surface of barrel 19 so that the brush head assembly 12 may be fully enclosed within the lower section 36 (indicated by dashed line 44) for storage or transport,

The lower outer surface of barrel section 19 and inner surface of cover 36 are formed with complementary separable fittings, e.g., circular ridge 33 on barrel 19 and circular receiving groove 35 within cover 36, for example, which allow them to be removably joined together so that the brush head 16, stem 14 and at least a portion of barrel 19 are fully enclosed within the cover 30, for storage or transport and then can be easily separated by hand for use.

FIG. 2D: Alternate Cover Joined to Canister and Brush Head

Near the lower end of canister body 9, an inward projecting interior lip 66 extends circumferentially around the interior of the canister wall. A matching groove 68 is disposed between upper and lower faces of the base 22, and defined around its outer circumference. The lip 66 is slidably received within the groove 68 so that the base 22 rotatable within the body 9 but is longitudinally fixed within the canister by the lip 66.

A circular disc member 70 acts as a plunger to press toothpaste out of the canister. The disc 70 is extends laterally across the interior of the canister body 9 and is longitudinally slidable therein. The disc is longitudinally positioned within the canister 11 by a helically threaded rod 72 fixed at its lower end to the top center of base member 22. The rod is centrally disposed within canister 11, and extends longitudinally between its lower fixed end its opposite end disposed adjacent to, but separated from, the dispenser tip 20 near the upper end of the canister.

With a full canister, the disc is positioned at the lower end of the rod adjacent to the top of the base with toothpaste filling the remaining interior of the canister. As the base is rotated with respect to the canister, toothpaste is dispensed out of the tip into the channel. Further rotation of the base forces toothpaste up in to the channel into the brush head and out into the bristles as discussed further below.

FIG. 2E Canister Joined to Brush Head Orifice

Referring to now to FIG. 2E brush head assembly 12 and canister 11 are shown threaded together in a fully engaged position ready for transferring toothpaste from canister 11 to the brush head bristles 18.

The interior wall of the channel 21 near the distal end of the stem 14 is stepped outward to form a peripheral rim 60. The proximal end of dispenser tip 20 protrudes beyond rim 60 and is received into the distal end of channel 21. Adjacent to the end of tip 20 the body of the tip widens to form a shoulder 62 distal from the channel rim 60. A sealing gasket 64 is compressed between the rim 60 and shoulder 62 and provides a seal preventing toothpaste flowing from the canister 9 into the channel 21 from escaping into any space between the adjacent inner wall of barrel 19 and the adjacent outer wall of canister 9

Disposed within the bristle array 18 there is a distributed self-sealing orifice 17. orifice 17 flowingly communicates between the proximal end of channel 21a and the bristles 18 at the end of the brush head 16. The brush head receives toothpaste from canister 11 delivered through the proximal end of channel 21, and delivers toothpaste through the distributed self-sealing orifice 17 to the brush head bristle array 18.

FIG. 2F and FIG. 2I, Self-Sealing Orifice.

There is shown a magnified frontal view of the face of brush head 16 with array of bristles 18 distributed thereon.

In the embodiment of the present invention depicted in FIG. 2E the distributed self-sealing orifice 17 takes the form of a set of three spaced apart cylindrical apertures 102 formed in the face of the brush head. The apertures are disposed near the top, middle, and bottom of the bristle array 18. A thin, resilient sheet member 104, e.g., plastic, completely covers each aperture. Each of the sheet members in each aperture is divided into three contiguous sectors 106 arranged sequentially around the periphery of its respective aperture. Three Radial separations 108 distributed around the periphery extend to the center of each aperture 102 and divide adjacent sectors 106 into separate cantilevered sections from their outer ends 110 fixed at the aperture periphery to respective central free ends where they abut in the center of the aperture covered by the three sectors.

This permits each sector to resiliently deflect under pressure of toothpaste that comes through the channel 21 under pressure from the canister 11.

Additionally, after the flow of toothpaste from the channel is ended, the resilient nature of the sheet member causes the sectors to relax and tends to inhibit the reverse flow of toothpaste from the bristles into the channel 21.

The distributed apertures provide a more uniform delivery of toothpaste across the bristle array than a single aperture.

FIG. 2G; Alternate Distributed Aperture Orifice

FIG. 2G shows a alternate distributed orifice of the present invention that has three cylindrical apertures 102 covered by a resilient sheet 104 divided into four contiguous cantilever sectors by four radial separations extending from their fixed ends at the aperture's periphery to their free ends at its center.

FIG. 2H; Alternate Slot Orifice

FIG. 2H shows another alternate embodiment of the distributed self-sealing orifice of the present invention. The aperture of the alternative shown in FIG. 2H is a single longitudinal slot 112 extending along the longest dimension of the bristle array 18 and has a comparable length. The slot 112 has a width substantially less than the bristle array 18.

The slot aperture 112 is covered by two resilient cantilever sheet sections 114 extending inward from opposite ends fixed at the two longest opposite edges of the slot 112 to abutting adjacent free ends in the middle of the slot. The cantilever sections 114 extend laterally to opposite free edges adjacent to the lateral shortest dimensions of the slot aperture 112.

FIG. 2I; Detail of Aperture Valve in 2F Before Delivery

FIG. 2I shows a cross section of the cantilever sheet sectors 106 disposed in their normal unflexed positions before delivering toothpaste to the bristles 18.

FIG. 2J; Detail of Aperture Valve in 2F During Delivery

The cross section in FIG. 2J shows the toothpaste flowing from the channel end, through the apertures 104 under the forcing pressure communicated through the channel 21 originating from the toothpaste forcing mechanism of canister 11.

FIG. 2J shows a cross section of the cantilever sheet sectors 106 disposed with their free ends deflected by pressure from toothpaste 13 in the brush head to provide an opening so that toothpaste 13′ is delivered into the bristles 18.

FIG. 2K; Detail of Aperture Valve in 2F after Delivery

FIG. 2K shows the resilient cantilever sections 106 disposed in a closed, undeflected state after toothpaste 13 is no longer flowing from the canister into the brush head.

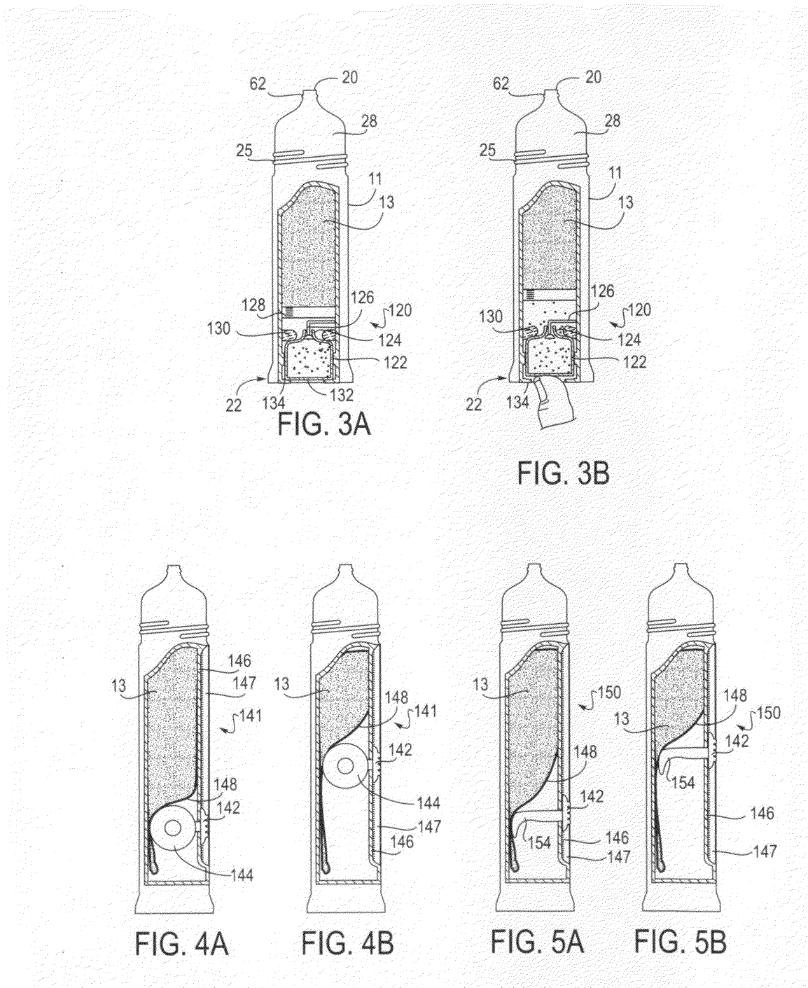

FIG. 3A: Alternative Pressure Canister Cross Section

FIG. 3A shows a partial cut-away view of an alternative toothpaste dispensing pressure canister 120 for the present invention. The canister 120 retains external features of the toothpaste dispenser assembly 11 of FIG. 1A the screw threads 25, the dispensing tip 20, shoulder 62, proximal top end 28 and supporting base 22 but differs in the manner of driving toothpaste 13 from inside the canister body 11 through the dispenser tip 20.

a longitudinally slidable, circular plunger disc 128 extends laterally across the inside of canister body 11.

When the canister is filled with toothpaste, the disc 128 is positioned longitudinally within the body 11 with its proximal face in contact with the distal extent of the stored toothpaste.

Spaced between the disc's distal face and the bottom of the canister, there is disposed a pressurized cylindrical aerosol container 122 mounted closely fitting within the body 11. The container 122 is disposed with its bottom end adjacent to the base 22. The bottom of the container 122 is restrained within the body 11 by a rigid inward projecting rim 132 disposed around the inside of body 11 at its distal end. The bottom of the container is accessible through the distal end of the canister's base inside the rim 132.

The pressure container has a pressure release valve 124 centered on the containers upper end and faces toward the plunger disc 128. The valve 123 is spaced away from the distal face of the disc 128.

A rigid valve release actuator member 126 is disposed between the valve 124 and the spaced away disc's distal face. The actuator 126 has one end fixed to the inside of canister body 11. The actuator extends inward from its fixed end toward its opposite actuating end disposed at the center of canister body 11. The actuator has its opposite end angled distally and disposed longitudinally so that it points directly toward and adjacent to the valve 124 when the bottom of the container is adjacent to the restraining rim 132.

The pressure container 122 is urged distally toward the restraining rim 132 by a longitudinally resilient ring member 130 in overlapping contact with the containers upper end. The ring member 130 is fixed longitudinally and circumferentially within the body 11 between the disc's distal face and the container's upper end. The ring extends inwardly around the inside of body 11 and spaced away from the central release valve 124. The ring 130 extends inward to overlap and contact an outermost portion of the containers upper end without contacting or interfering with the actuator member 126 or the containers release valve 124.

FIG. 3B: Canister of FIG. 3A Dispensing Toothpaste.

When the bottom of the container 122 is pressed, indicated by the finger in FIG. 3B, the container moves up in the body 11, deforming the resilient restraining member 130 until the actuating end of the actuator 126 makes contact with the valve 124, releasing gas which drives the plunger to press toothpaste 13 out of the dispensing tip 20. The container's bottom is recessed within the base 22 so that the chance of inadvertent discharge of toothpaste is minimized when the canister 120 is vertically stood on its base 22.

FIG. 4A; Alternative with Roller Dispensing Canister

Referring to FIGS. 4A and 4B a partial cut-away view of the interior of an alternative toothpaste dispenser assembly 140 component of the present invention is shown. The canister 140 has a proximal end 28 with dispenser tip 20, abutting shoulder 62 and mating threads 25 for connecting to the internally threaded barrel of brush head assembly 14 of the present invention.

The canister body encompasses a conventional toothpaste tube 148 (without its cap), containing toothpaste 13 to be dispensed through the dispenser tip 20 into the brush head assembly 12 of FIG. 1A. The threaded end of the uncapped tube is fixed within the canister body by conventional means (not shown: for example, engaged with mating female threads inside the proximal end 28 of the canister body) so the open tube end is aligned and connected flowingly with the inside of the dispenser tip 20 enabling toothpaste to flow out of the tube to be dispensed out of the tip 20.

A thumb-operated slide actuator 142 is disposed on the outside of the canister wall and rigidly connects to an axle 143 inside the canister body 9. A roller 144 is rotatably mounted on the axle 143 and extends transverse to the tube 148 and between the tube and the actuator slider 142. The slider 142 rides in a recessed longitudinal slot 146 formed in the canister wall at the bottom of a longitudinal groove 147 extending along the canister body 9. The outside surface of slider 142 is preferably flush with the canister wall at the top of groove 147.

The axle-mounted roller is rotatably disposed on the axle 143 between the adjacent tube body and the actuator slider so that it compressively contacts the tube body, tending to flatten the tube and force toothpaste to flow out of the proximal tube end and subsequently out of the dispenser tip 20.

FIG. 4B: Alternative of 4A while Dispensing.

Continued movement of the slider toward the dispenser tip 20 (FIG. 4B) continues to force the roller to flatten successively more of the tube and deliver more toothpaste from the tip 20.

FIGS. 5A and 5B.

With reference to FIGS. 5A and 5B, there is shown another alternative toothpaste dispensing canister assembly 150 for the present invention. As before the assembly 150 contains the toothpaste tube 148 fixed to the inside proximal end of the canister. It also includes the proximal canister end 28 with dispenser tip 20, abutting shoulder 62 and mating threads 25 for connecting to the internally threaded barrel of brush head assembly 14 of the present invention.

As in FIG. 4A, the canister 150 has a slider 142, riding outside the canister in recessed slot 146 at the bottom of longitudinal groove 147. However, the canister 150 of FIGS. 5A and B has a semi-rigid transverse wiper 154, instead of a roller, that extends from the slider 142, making compressive contact with the tube as the slider is moved along the canister.

Knowledgeable practitioners of the art will appreciate that the scope of the IVR invention is not limited to the embodiments, form factors, interfaces, connections, and operating functions described above, but are limited only by the claims herein. The present invention has been described in what is considered as preferred embodiments. However, it should be noted that the invention can be practiced otherwise than as specifically described and illustrated without departing from the scope or spirit of the invention.

What is claimed is:

1. A hand-held dental appliance, comprising;
a. a longitudinal toothbrush stem comprising;
i. a brush head at its proximal end;
ii. a connecting socket at its distal end, said stem defining a hollow interior passage to the brush head from a toothpaste receiving inlet disposed in said socket end;
iii. a set of valved orifices defined on said brush head, distributed among an array of projecting bristles, said orifices fluidly communicating through said passage to said receiving inlet in said connecting socket, wherein said valved orifices inhibit return flow of toothpaste from said bristles into said stem passage;
b. a longitudinal toothpaste delivery canister with a proximal end and a distal end, said proximal end forming a connector adapted to separably join said canister proximal end to said socket end with a dispenser tip projecting from said canister proximal end to connect in fluid communication with said receiving inlet;
c. a toothpaste delivery actuator housed within said canister, said actuator driving a movable member that forces the canister's stored toothpaste from the dispenser tip to the brush head through the stem passage.

2. The hand-held dental appliance as set forth in claim 1, further comprising:
a. a removable cover for protecting the proximal toothbrush stem, comprising:
i. a distal housing having a proximal end and an open distal end configured so that said housing receives and encloses the toothbrush stem through said open distal end.

3. The hand-held dental appliance as set forth in claim 2, further comprising:
a. a hinged lid on the proximal end of the housing that covers a dental floss retainer contained inside the cover when the lid is closed;
b. a floss dispensing aperture and adjacent cutter disposed adjacent to said lid, said cutter adapted to cut lengths of floss protruding through said aperture from dental floss retained within said cover.

4. The hand-held dental appliance as set forth in claim 1,
a. wherein each of said valved orifices comprise a plurality of thin, flexible, flap members extending from fixed edges at the perimeter of said orifices to respective free ends, such that, when said flaps are not flexed, the free ends of adjacent flaps abut so that each of said orifices are covered by said abutting flaps, inhibiting return flow of toothpaste through the orifices from the head into the passage, wherein said orifices are partially uncovered when said free ends of said flaps are flexed to separate under pressure of toothpaste forced from said passage into said bristles;

5. The hand-held dental appliance as set forth in claim 1, wherein said joined canister and stem comprise:
a. a sealing gasket between the dispenser tip and the interior of the brush head connecting socket, said gasket restricting toothpaste to flow only from the dispenser tip into the passage inlet.

6. The hand-held dental appliance as set forth in claim 1,
a. wherein said connectors of said canister and toothbrush stem are cooperating threaded connectors.

7. The hand-held dental appliance as set forth in claim 1,
a. wherein said connectors of said canister and said toothbrush stem are cooperating bayonet type connectors.

8. The hand-held dental appliance as set forth in claim 1, wherein said delivery actuator comprises:
a. A distal base member comprising: a rotatable knurled wheel at the distal end of said canister connected to an internal shaft threaded through the center of a longitudinally movable circular disc, wherein rotating said wheel drives said disc longitudinally to force said stored toothpaste in said canister through said dispensing tip toward said brush head when said toothbrush stem and said canister are connected.

9. The hand-held dental appliance as set forth in claim 1: wherein said delivery actuator comprises:
a. A distal base member comprising:
i. a rotatable member at the distal end of said canister connected to an internal shaft threaded through the center of a longitudinally movable circular disc with a proximal face in contact with said stored toothpaste, wherein said disc is advanced longitudinally by rotating said shaft and thereby forcing said stored toothpaste through said dispensing tip toward said brush head when said toothbrush stem and said canister are connected, in which said rotatable member comprises:
1. A distal face defining opposed distal recesses on opposite sides of a recessed longitudinal internal flange, said internal flange adapted to be gripped from said opposed recesses to rotate said base member in a direction to advance said movable disc.

10. The hand-held dental appliance as set forth in claim 1: wherein said delivery actuator comprises:
a. An actuating knob slidingly supported in a recessed longitudinal slot a the bottom of a groove defined along the outside of a body portion of said canister, said knob connected to a lateral sliding wedge pressing against a toothpaste containing tube housed in said canister such that, as the knob is move proximally along said canister body, toothpaste is urged from a dispensing tip of the tube into the receiving inlet of the toothbrush stem, through said passage, and out of said orifice, whereby toothpaste is delivered into said bristles.

11. The hand-held dental appliance as set forth in claim 1, wherein said delivery actuator comprises:
a. An actuating knob slidingly supported in a recessed longitudinal slot a the bottom of a groove defined along the outside of a body portion of said canister, said knob connected to an axle rotatably supporting a roller member pressing against a toothpaste containing tube housed in said canister, said tube having a dispensing outlet with said outlet in fluid communication with said canister's dispenser tip, such that, as said knob is moved proximally along said canister body, said roller member rolls along said tube to force toothpaste from said dispensing tip into the receiving inlet of the toothbrush stem, through said passage, and out of said orifice, whereby toothpaste is delivered into said bristles.

12. The hand-held dental appliance as set forth in claim 1, wherein said delivery actuator comprises:
a. A longitudinally movable disc positioned with a proximal face in contact with toothpaste stored in said canister;
b. A pressurized aerosol container slidingly disposed between said disc and a distal restraining member fixed at the base of the canister, said distal restraining member preventing said container from moving beyond the distal end of the canister, in which said container further comprises:
c. a pressure release valve disposed on its upper end, said valve spaced away and from facing toward said disc, said container having a bottom end recessed from and open to the distal end of the canister;
d. wherein said canister additionally comprises:
e. a longitudinally resilient biasing member fixed to the inside of the canister that biases the container toward the distal restraining member;
f. A rigid valve actuator member supported within the canister between the valve and the disc so that it is proximal to but separated from the valve by the resilient biasing member;
g. wherein, when the container is moved against said resilient biasing member toward the proximal end of the canister, and contacts said valve actuator, said valve opens and said container pressurizes said space between said container and said disc, moving said disc longitudinally to force toothpaste from said canister dispenser tip, through said passage, and out of said orifice, whereby toothpaste is delivered into said bristles.

13. The hand-held dental appliance as set forth in claim 1, wherein said delivery actuator comprises:
a. a toothpaste delivery canister containing an amount of toothpaste limited to that required for air travel.
